(19) United States
(12) Patent Application Publication
(10) Pub. No.: US 2012/0129369 A1
(43) Pub. Date: May 24, 2012

(54) ELECTRIC VEHICLE BREAKAWAY CABLE

(76) Inventors: John Bogart, Oxford, CT (US); Craig Murphy, Cromwell, CT (US)

(21) Appl. No.: 13/301,884

(22) Filed: Nov. 22, 2011

Related U.S. Application Data
(60) Provisional application No. 61/416,464, filed on Nov. 23, 2010.

(51) Int. Cl. H01R 13/62; H01R 43/00

(52) U.S. Cl. 439/153; 29/825

(57) ABSTRACT

A breakaway cable for an electric vehicle charging system comprises a female portion connected to a first cable and a male portion connected to a second cable. The female portion comprises a tang located at an end of the female portion. The male portion is configured to receive the female portion and comprises a catch and a lip, both the catch and the lip being located on an inner surface of the male portion. Upon engagement of the tang with the lip, the tang is disengagable from the lip by application of force. The tang is disengagable from the catch by further application of force.

### CROSS REFERENCE TO RELATED APPLICATION

This application claims the benefit of U.S. Provisional Patent Application No. 61/416,464, filed on Nov. 23, 2010, the contents of which are incorporated herein by reference in their entirety.

### TECHNICAL FIELD

The present invention is directed to breakaway cables for electric vehicles and, more particularly, to a breakaway cable that is capable of separating into two portions such that two devices connected by the breakaway cable are not compromised.

### BACKGROUND

New EV (electric vehicle) models are increasingly being introduced by auto manufacturers into the consumer automobile market. With an increase in the number of EVs in use, additional charging stations are likely to be brought on line in order to provide for efficient and cost-effective charging of these EVs. Many charging station companies are introducing charging units that are designed to be used at the home or garage of the EV owner, as well as in public (e.g., parking lots, malls, etc.)

These charging units will require a cable to run between the EV and the charging station. There may be instances where these cables are inadvertently stressed from a second force in the environment or if the vehicle rolls away from the charging station. In such instances, a mechanism for releasing the cable to prevent damage to the EV or the charging station may be employed. While the cable generally employs a “plug in” type of connector, it can prove difficult to disengage the connector if angular forces are applied to the connector. If sufficient angular force is applied, the charging station and/or the EV can be damaged.

Configurations have been proposed to have the breakaway occur at the connector that plugs into the EV. However, given that damage may occur to the EV in doing so, this may be an undesirable approach. Furthermore, because of the proximity of the driver (and occupants) to a breakaway occurring at the EV, such a breakaway at the connector is additionally undesirable. Also, unless the cable assembly is pulled straight out of the receptacle into which the cable assembly is inserted (i.e. if the pull occurs up or down or to either side), the EV charging system may not shut down and/or damage may occur to the EV.

Configurations have also been proposed to incorporate the breakaway/shut down feature in the charging station itself. However, this and similar configurations would involve changes in the internal wiring to the charging station and would therefore involve the use of a field technician to maintain and reset the charging station after each pull incident.

### SUMMARY

In one aspect, the present invention resides in a breakaway cable for an electric vehicle charging system. The breakaway cable comprises a female portion connected to a first cable and a male portion connected to a second cable. The female portion comprises a tang located at an end of the female portion. The male portion is configured to receive the female portion and comprises a catch and a lip, both the catch and the lip being located on an inner surface of the male portion. Upon engagement of the tang with the lip, the tang is disengagable from the lip by application of force. The tang is disengagable from the catch by further application of force.

In another aspect, the present invention resides in a breakaway connector for an electric vehicle charging station. Such a breakaway connector comprises a first cable having a first end connected to the electric vehicle charging station, and a second cable having a first end connectable to an electric vehicle. A female portion is coupled to a second end of the first cable, and a male portion is coupled to a second end of the second cable. The male portion is connected to the female portion. Electrical communication is maintained through the first cable, the male portion, the female portion, and the second cable to charge the electric vehicle. The male and female portions are separable from each other upon the application of forces that pull the male and female portions in opposing directions. While the present invention has been described as having a female portion coupled to a second end of the first cable and a male portion coupled to a second end of the second cable, the present invention is not limited in this regard as the male and female portions can be interchanged without departing from the broader aspects of the invention.

In another aspect, the present invention resides in a method of breaking an electrical connection between an electric vehicle charging station and an electric vehicle. In this method, a breakaway electrical cable is provided between the electric vehicle charging station and the electric vehicle, and electricity is conducted through the breakaway electrical cable to charge the electric vehicle. The breakaway electrical cable comprises a female portion connected to one end of one of the first and second cables, the female portion comprising a tang located at an end of the female portion, a second end of the first cable being connected to the electric vehicle charging station, and a male portion connected to one end of the other of the first and second cables, the male portion receiving the female portion and comprising a catch and a lip. Both the catch and the lip are located on an inner surface of the male portion. A second end of the second cable is connected to the electric vehicle. To break the electrical connection, the tang is disengaged from the lip and the catch by the application of force. A lesser amount of force disengages the tang from the lip, and a greater amount of force disengages the tang from the catch.

### BRIEF DESCRIPTION OF THE DRAWINGS

FIG. 1 is a schematic representation of in line breakaway connectors fully engaged/mated, for a charging cable for an EV charging station.

FIG. 2 is an end view of a charging cable for an EV charging station.

FIG. 3 is schematic representation of internal components of the connector of FIG. 1.

FIG. 4 is a schematic representation of the connector of FIG. 1 in a disconnected/disengaged configuration.

FIG. 5 is a schematic representation of a connection detail of the connector of FIG. 1.

FIG. 6 is a schematic representation of another connection detail of the connector of FIG. 1.

FIG. 7 is a schematic representation of another connection detail of the connector of FIG. 1.

### DESCRIPTION

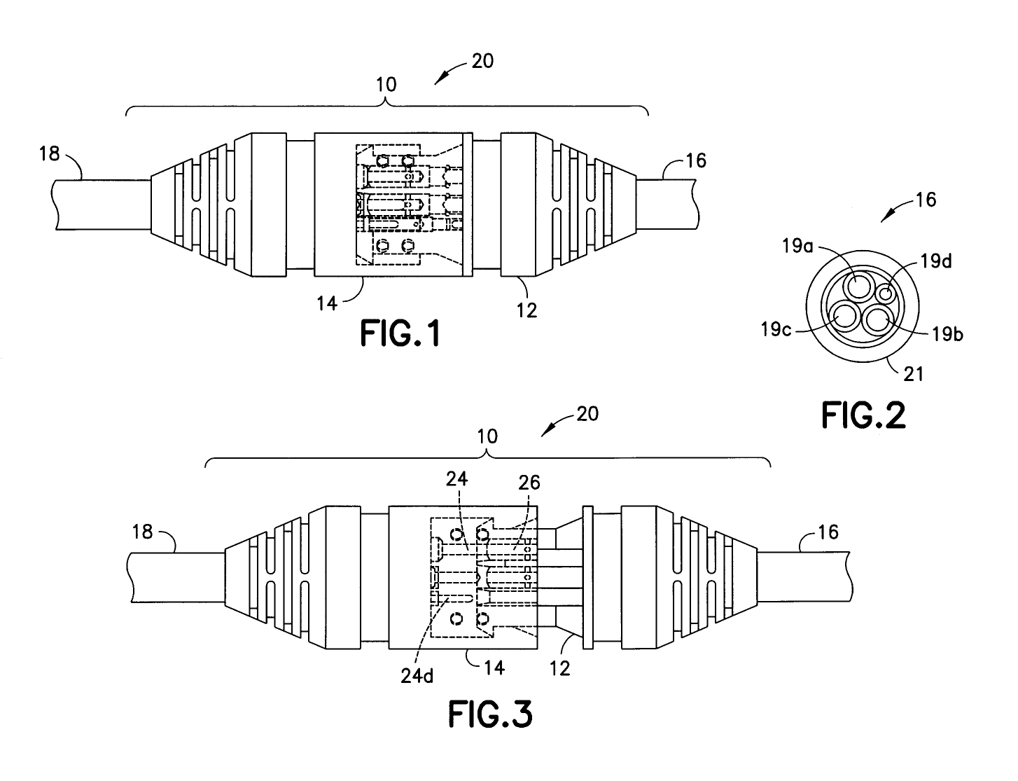

Referring to FIG. 1, a set of breakaway connectors for use with a cable of a charging system for an EV is designated generally by the number 10 and is hereinafter referred to as “connector 10.” The connector 10 comprises a female portion 12 and a male portion 14, the assembly of which connects a first cable 16 to a charging station and a second cable 18 to an EV at a distal end of the second cable. The female portion 12 and the male portion 14 are each permanently molded to the first cable 16 and the second cable 18, respectively. The connector 10 is configured to unplug and shut down the charging station at a pre-selected amount of pull or strain (e.g., about 60-70 pounds). The connector 10 and the first cable 16 and the second cable 18 are provided as a complete cable assembly 20.

The female portion 12 and the male portion 14 are each molded of a thermoplastic or a material having elastomeric properties, each being molded as an integral part of the cable assembly 20. Because each female portion 12 and male portion 14 is integrally molded to a respective cable, the connection of each portion to its respective cable portion is waterproof. The use of a thermoplastic or material having elastomeric properties also provides for electrical and thermal insulation of the connector 10. Furthermore, such an integral connection allows the cable assembly 20 into which the connector 10 is incorporated to withstand pull or strain forces that are greater than comparable forces exerted on a connector in which the male and female portions are not integrally molded to their respective cables. The present invention is not limited to the female portion 12 and the male portion 14 being molded as an integral part of the cable assembly 20, however, as the such portions may be coupled to the cable assembly.

Referring to FIG. 2, both the first cable 16 and the second cable 18 include four conductor wires, namely a first power wire 19a, a second power wire 19b, a ground wire 19c, and a signal wire 19d. The first power wire 19a, the second power wire 19b, and the ground wire 19c are insulated wires of 10 American wire gauge (AWG), and the signal wire 19d is an insulated wire of 18 AWG. The present invention is not limited in this regard, as the conductor wires may be of any suitable gauge. When arranged as the first cable 16 and the second cable 18, the conductor wires are contained in a jacket 21 of suitable material, such as chlorinated polyethylene. The present invention is also not limited in this regard, as any other suitable thermoplastic or elastomer may be employed as the material of the jacket 21.

Referring to FIG. 3, the male portion 14 contains brass pins 24 that are received into holes, slots, or similar receptacles 26 in the female portion 12. The pins 24 (only three of which are shown) as well as the receptacles 26 are plated with nickel and tin to provide suitable corrosion resistance. Both the pins 24 and the receptacles 26 are also constructed and sized to accommodate amounts of amperage through the cable assembly 20 that are suitable to charge an EV. For example, the pins 24 and the receptacles 26 through which electrical current is conducted to charge the EV are constructed and sized to accommodate up to about 40 amps on a continuous basis and about 80 amps peak. The present invention is not so limited, however, as the pins 24 and receptacles 26 may be constructed to accommodate greater amperages therethrough. Also, the pins 24 are not limited to being brass and the receptacles 26 are not limited to being plated with nickel and tin, as other materials may be used. Furthermore, the present invention is not limited to a four pin/four receptacle configuration, as any suitable number of pins and receptacles may be employed.

In the illustrated embodiment, the pins 24 are sized such that a signal pin 24d connected to the signal wire 19d is shorter than the other pins. When all of the pins 24 are received into receptacles 26, electrical communication and continuity are maintained across the connector 10. In maintaining electrical communication, a signal is transmitted through the signal pin 24d when the signal pin is inserted into its receptacle 26. Because the signal pin 24d is shorter than the other pins 24, upon connecting the female portion 12 to the male portion 14, the signal pin 24d is the last pin to engage a receptacle 26. Also, upon separation of the female portion 12 from the male portion 14, the signal pin 24d is the first pin to disengage a receptacle 26. Accordingly, a signal to begin a charging operation is transmitted only after the pins 24 through which current is transmitted are engaged, and a signal to terminate a charging operation is transmitted before the current-carrying pins 24 are disengaged. By configuring the signal pin 24d in this manner, a charging operation can be effectively shut down before the current carrying pins 24 are separated from their respective receptacles 26, thereby potentially avoiding arcing or other electrical hazards.

The first cable 16 and the second cable 18 are sufficiently long enough to allow the cable assembly 20 to swing away from the charging station at any angle. In doing so, a pull incident would allow the connector 10 to swing in the direction of the pulling force, thereby allowing the pins 24 to be pulled straight out from the receptacles 26, and thereby also avoiding the imposition of any sideward pulling forces on the connector 10.

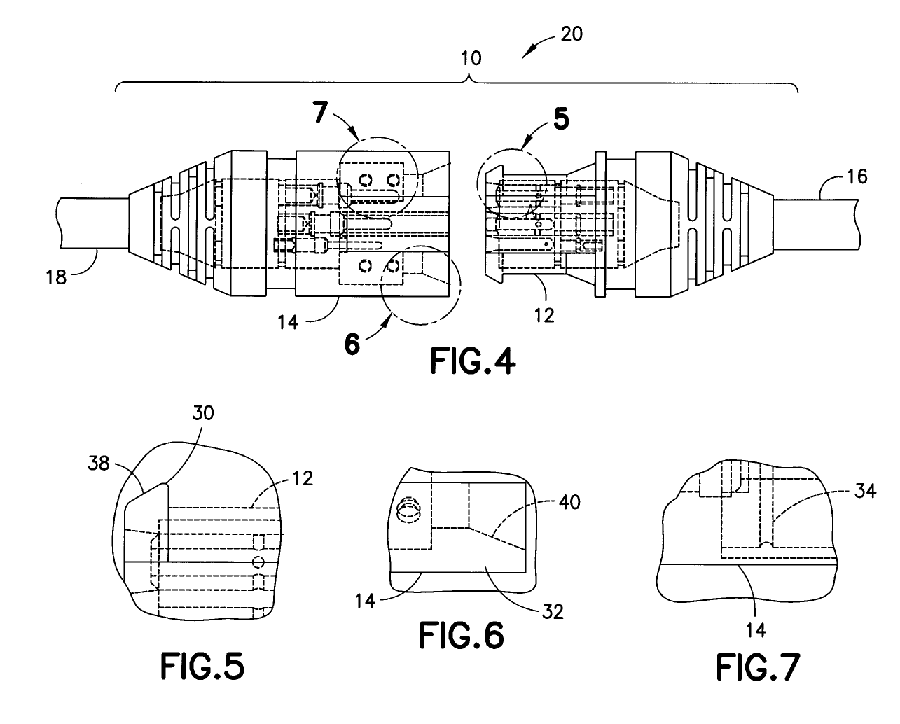

Referring to FIG. 4, the connector 10 employs a “ridge system” to address the problem of intentional separation of the female portion 12 from the male portion 14 due to theft or tampering with the cable assembly at the charging station. In particular, since only 60-70 lbs of pull is used to separate the female portion 12 from the male portion 14, it may be possible in charging systems of the prior art to unplug the connector 10 and steal one portion of the cable assembly. Since the value of the cable assembly and the connector 10 (which may comprise an NEC-J1772 connector) is substantial, at least in part due to the value of the copper in the connector, the allure of theft is a concern that is addressed and prevented by the ridge system.

As is shown in FIGS. 5-7, the ridge system comprises a tang 30 extending circumferentially around an outer end of the female portion 12, a catch 32 extending circumferentially around an inner surface of an end of the male portion 14, and a lip 34 extending circumferentially around an inner surface of the male portion distal from the end thereof. The tang 30 is defined in part by a first angled surface 38 that, when the female portion 12 is connected to the male portion 14 during assembly of the cable assembly 10 (e.g., by the manufacturer), either compresses the end of the female portion radially inward or stretches the open end of the male portion radially outward to allow the tang to slide over a second angled surface 40 (FIG. 5) and through the catch 32. A substantial insertion force is exerted to press the female portion 12 over the catch 32 and into the male portion 14. Accordingly, the insertion of the female portion 12 into the male portion 14 is generally carried out during the assembly of the connector 10, which may be during manufacture or assembly of the connector 10. Further insertion of the female portion 12 into the male portion 14 (which may be by hand) causes the tang 30 to slide over the lip 34 (FIG. 6).

The “ridge system” is thereby configured such that an effort to separate the female portion 12 from the male portion 14 utilizes about 60-70 pounds of force to pull the tang 30 back over the lip 34. In doing so, the ridge system allows for separation of the pins 24 from the receptacles 26 (stopping the charging operation without arcing) but maintaining the connection of the female portion 12 with the male portion 14. Further pulling the tang 30 back over the catch 32 utilizes about 300 pounds of force. Thus, the connector 10 unplugs with a standard amount of force to prevent stress on the cables and thereby prevents intentional theft and tampering, yet the connector completely separates only upon exertion of about 300 pounds of force. Furthermore, the connector 10 is rugged enough to withstand commercial/in field use for an extended period of time.

As stated above, a “pull incident” may involve the attempted disconnection and/or complete separation of the breakaway connectors due to either manual application of opposing forces to each of the male and female portions or to movement of the EV from the charging station. Upon experiencing a pull incident, forces of about 60-70 pounds up to about 300 pounds allow for the separation of the pins from the receptacles so that power to the EV is shutdown. The male and female portions in this situation would remain engaged. Forces greater than about 300 pounds, e.g., due to a roll away, allow for disconnection of the pins and receptacles with the cable assembly completely separating. With less than a complete separation (such as only disconnection of the pins from the receptacles), the system can be reset by a user by simply plugging the female portion 12 back into the male portion 14 of the connector 10 and following directions on a display panel of the charging station. Thus, the need for a field technician to perform maintenance and reset the charging system after this type of pull incident is eliminated.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above description, but that the invention will include all embodiments falling within the scope of the appended claim.

What is claimed is:

1. A breakaway cable for an electric vehicle charging system, the breakaway cable comprising:
a female portion connected to a first cable, the female portion comprising a tang located at an end of the female portion; and
a male portion connected to a second cable, the male portion being configured to receive the female portion and comprising a catch and a lip, both the catch and the lip being located on an inner surface of the male portion;
wherein upon engagement of the tang with the lip, the tang is disengagable from the lip by the application of force and the tang is disengagable from the catch by further greater application of force.

2. The breakaway cable of claim 1, wherein the tang extends circumferentially around the end of the female portion, the catch extends circumferentially around the inner surface of the male portion, and the lip extends circumferentially around the inner surface of the male portion distal from the end of the male portion.

3. The breakaway cable of claim 1, wherein the tang is defined in part by an angled surface that either compresses the end of the female portion radially inward or stretches an open end of the male portion radially outward when the tang is inserted past the catch.

4. The breakaway cable of claim 1, wherein the male portion comprises a plurality of pins and wherein the female portion comprises a plurality of receptacles in which the pins are correspondingly received, at least two of the pins allowing for the conduction of electrical current through the cable.

5. The breakaway cable of claim 4, wherein one of the pins of the plurality of pins is a signal pin that is capable of transferring a signal to the electric vehicle charging station to shut down a charging operation upon separation the signal pin from a respective receptacle.

6. The breakaway cable of claim 4, wherein one of the pins of the plurality of pins is grounded upon being received in a respective receptacle.

7. The breakaway cable of claim 1, wherein about 60-70 pounds of force is used to pull the tang over the lip.

8. The breakaway cable of claim 1, wherein about 300 pounds of force is used to pull the tang out of the catch.

9. A breakaway connector for an electric vehicle charging station, the breakaway connector comprising:
a first cable having a first end connected to the electric vehicle charging station;
a female portion coupled to a second end of the first cable;
a second cable having a first end connectable to an electric vehicle; and
a male portion coupled to a second end of the second cable and connected to the female portion;
wherein electrical communication is maintained through the first cable, the male portion, the female portion, and the second cable to charge the electric vehicle.

10. The breakaway connector of claim 9, wherein the female portion comprises a tang located at an end of the female portion and the male portion comprises a catch and a lip, both the catch and the lip being located on an inner surface of the male portion; and
wherein upon engagement of the tang with the lip, the tang is disengagable from the lip by application of force and the tang is disengagable from the catch by further greater application of force.

11. The breakaway connector of claim 10, wherein the tang extends circumferentially around the end of the female portion, the catch extends circumferentially around the inner surface of the male portion, and the lip extends circumferentially around the inner surface of the male portion distal from the end of the male portion.

12. The breakaway connector of claim 10, wherein the tang is defined in part by an angled surface that either compresses the end of the female portion radially inward or stretches an open end of the male portion radially outward when the tang is inserted past the catch.

13. The breakaway connector of claim 10, wherein the first cable and the second cable each comprise a plurality of wires extending therethrough, each of the wires of the first cable being connectable to the wires of the second cable.

14. The breakaway connector of claim 13, further comprising a pin on each of the wires of the first cable and a receptacle on each of the wires of the second cable, wherein the wires of the first cable are connectable to the wires of the second cable via the engagement of each of the pins with a respective receptacle.

15. The breakaway connector of claim 14, wherein one of the pins on one of the wires of the first cable is shorter than each of the remaining pins such that the shorter pin can be disengaged from a respective receptacle while the remaining pins remain engaged with their respective receptacles, the disengagement of the shorter pin from its corresponding receptacle being configured to provide a signal to terminate electrical communication through the first cable, the male portion, the female portion, and the second cable to charge the electric vehicle.

16. The breakaway connector of claim 10, wherein about 60-70 pounds of force is used to pull the tang over the lip, and wherein about 300 pounds of force is used to pull the tang out of the catch.

17. The breakaway connector of claim 9, wherein the female portion is integrally molded to the second end of the first cable, and wherein the male portion is integrally molded to the second end of the second cable.

18. A method of breaking an electrical connection between an electric vehicle charging station and an electric vehicle, the method comprising:
providing a breakaway electrical cable between the electric vehicle charging station and an electric vehicle, the breakaway electrical cable comprising,
a female portion connected to one end of a first cable, the female portion comprising a tang located at an end of the female portion, a second end of the first cable being connected to the electric vehicle charging station, and
a male portion connected to one end of a second cable, the male portion receiving the female portion and comprising a catch and a lip, both the catch and the lip being located on an inner surface of the male portion, a second end of the second cable being connected to the electric vehicle;
conducting electricity through the breakaway electrical cable to charge the electric vehicle;
disengaging the tang from the lip by the application of force; and
disengaging the tang from the catch by the further application of force.

19. The method of claim 18, further comprising conducting a signal through the breakaway electrical cable, the interruption of which by the disengagement of the tang from the lip terminates the conducting of electricity through the breakaway electrical cable before the disengagement of the tang from the catch.
